(19) United States
(12) Patent Application Publication
(10) Pub. No.: US 2015/0242818 A1
(43) Pub. Date: Aug. 27, 2015

(54) AUTOMATED SOCIAL SECURITY ELIGIBILITY TRANSMITTAL SYSTEM

(71) Applicant: Jeffrey A. Killian, Grove City, OH (US)

(72) Inventor: Jeffrey A. Killian, Grove City, OH (US)

(21) Appl. No.: 14/450,042

(22) Filed: Aug. 1, 2014

Related U.S. Application Data
(60) Provisional application No. 61/944,685, filed on Feb. 26, 2014.

(51) Int. Cl. G06Q 10/10; G06Q 50/26; G06F 19/00

(52) U.S. Cl. CPC G06Q 10/1057; G06F 19/328; G06F 19/322; G06Q 50/26

(57) ABSTRACT

A computerized system and method for determining eligibility for social security disability insurance benefits (SSDI) through a computer network. The network provides access to State databases containing information relating to persons receiving treatment for developmental disabilities and/or mental illness from a State licensed care facility and Federal Social Security records containing information relating to person's status of SSDI benefits and parental/marital information relating to person's eligibility of SSDI benefits. The system and method is programmed to automatically determine who is potentially eligible for SSDI benefits and determine those who are eligible for SSDI benefits based on the information identified within the State and Federal databases. Moreover, the computerized system and method may also automatically identify lump sum payments paid out on behalf of at least one person who is/are receiving treatment for disabilities and/or mental illness from a State licensed care facility.

### CROSS RELATED REFERENCES

This application claims priority to the Provisional Patent Application No. 61/944,685 filed on Feb. 26, 2014.

### BACKGROUND

The present invention pertains to a computerized system and method and, in particular, a system and method which is used for determining eligibility for Social Security Disability Insurance benefits through a computer network.

States currently provide treatment for people with developmental disabilities and mental illness in licensed intermediate care facilities or licensed community based homes. The cost of this treatment is extremely expensive and is partially offset by patient liabilities and the Federal government's Medicaid program, the balance is absorbed by State tax payer money.

Moreover, the financial burden of providing Medicaid services is climbing due to an ever increasing population in addition to the mounting regulatory requirements placed on the States by the Federal government, it has become critical for States to explore every opportunity to stretch their financial resources.

Typically, when a person with developmental disabilities or mental illness receives care licensed by a State, an amount is recovered from the person's unearned income to offset their cost of care, this recovery is called a “patient liability.” Then the balance of the cost of care, after deduction of the unearned income (patient liability), is submitted to the Federal government for reimbursement at a designated percentage rate less than 100%. The balance of cost of care after the deduction of patient liability and Federal Medicaid reimbursement is the State's true cost for treatment.

Social Security Disability Insurance (SSDI) is a payroll tax-funded, federal insurance program of the United States government proscribed by the Social Security Act which has been codified by Chapter 7 of Title 42 of the United States Code. It is managed by the Social Security Administration and is designed to provide income supplements to people who are physically restricted in their ability to be employed because of a notable disability, usually a physical disability. Social Security Disability Insurance can be supplied on either a temporary or permanent basis, usually directly correlated to whether the person's disability is temporary or permanent.

Monthly Social Security Disability Insurance benefits are a large source of patient liability recoveries. States have recognized this fact over the years and have pursued these benefits aggressively to include 1) Recovering Social Security Disability Insurance benefits already on hand and 2) Developing potential new monthly Social Security Disability Insurance benefits. Both efforts reduce the monthly cost of care outlays of both Federal and State government entities.

However, States have not been able to develop and maintain efficient processes in order to maximize Social Security Disability Insurance recovery. What is lacking from State efforts is a timely process that determines who is not currently receiving monthly Social Security Disability Insurance benefits, who has been overlooked to receive Social Security Disability Insurance benefits on a current basis, what steps are needed to secure the current monthly Social Security Disability Insurance benefits, and a process that constantly monitors the new eligibility status for future monthly Social Security Disability Insurance benefits.

The present invention provides a computerized method and system for reducing these problems. The difficulties inherent in the art are therefore overcome in a way which is simple, user friendly, and efficient—which provide better and more advantageous results.

### SUMMARY

For the foregoing reasons, what is needed is to provide a computerized method and system for determining the eligibility for Social Security Disability Insurance benefits through a computer network which is automated, easy to use, and efficient—which saves time and State and Federal funds.

The computerized method for determining eligibility for social security disability insurance (SSDI) benefits through a computer network, comprising the steps of: (a) providing a computer processing means and a computer readable media; (b) providing access to a Federal Social Security database through the computer network, wherein the Federal Social Security database provides records containing information relating to a person's status of SSDI and/or parental and/or marital information relating to eligibility for SSDI; (c) selecting at least one person who is identified as receiving treatment for developmental disabilities and/or mental illness; (d) creating an electronic data record comprising information relating to at least the identity of the selected person and social security number, wherein the electronic data record is recorded on the computer readable media; (e) retrieving person's Federal Social Security record containing information relating to person's status of SSDI benefits; (f) determining whether the selected person is receiving SSDI benefits based on the SSDI status information contained within the Federal Social Security database record through the computer network; and (g) indicating in the electronic data record whether the person is receiving SSDI benefits or is not receiving SSDI benefits.

In a version of the invention, the computerized method for determining eligibility for social security disability insurance benefits through a computer network may further provide access to a State database through the network, wherein the State database provides records containing information relating to persons receiving treatment for developmental disabilities and/or mental illness from a State licensed care facility, and wherein the step of selecting at the least one person who is identified as receiving treatment for developmental disabilities and/or mental illness is selected from the State database.

In a version of the invention, the computerized method determines whether the person indicated as not receiving social security disability insurance is eligible for receiving social security disability insurance benefits based on current legal requirements for SSDI benefits.

More particularly, in a version, the computerized method for determining eligibility for social security disability insurance benefits through a computer network comprises the steps performed, for at least one electronic data record of persons indicated as not receiving SSDI benefits, of: (a) identifying available parental and/or marital names and Social Security numbers of the person indicated in the electronic data record as not receiving SSDI benefits; (b) inputting into the electronic data record identified available parental and/or marital names and Social Security numbers; (c) retrieving parental and/or marital Social Security record(s) from the Federal Social Security database through the computer network in order to identify information for determining eligibility for SSDI benefits; (d) determining whether the selected person indicated in the electronic data record is eligible for receiving social security disability insurance benefits based on the identified information for determining eligibility for SSDI benefits and current SSDI benefit law; and (e) indicating in the electronic data record whether the person is eligible for SSDI benefits or does is not eligible for SSDI benefits.

In another version of the invention, the computerized method further comprises the ability to perform a periodic review of the electronic data records indicated as not eligible for SSDI benefits, wherein the periodic review comprises the steps of: (a) if not currently known, identifying available parental and/or marital names and Social Security numbers of the person indicated in the electronic data record as not receiving SSDI benefits; (b) inputting into the electronic data record identified available parental and/or marital names and Social Security numbers; (c) retrieving parental and/or marital Social Security record(s) from the Social Security database through the computer network in order to identify information for determining eligibility for SSDI benefits; (d) determining whether the selected person is eligible for receiving SSDI benefits based on the identified information for determining eligibility for SSDI benefits and current SSDI benefit legal requirements; and (e) indicating in the electronic data record whether the person is eligible for SSDI benefits or is not eligible for SSDI benefits.

These and other features of the present invention will become readily apparent upon further review of the following specification and drawings.

### BRIEF DESCRIPTION OF THE DRAWINGS

These and other features, aspects, and advantages of the present invention will become better understood with regard to the following description, appended claims, and accompanying drawings where:

FIG. 1 illustrates a computer network that provides a system in accordance with the invention;

FIG. 2 illustrates a processing system in components of the network in accordance with the invention;

FIG. 3 is a flow diagram of a process executed to provide the interface using a display for a system administrator computer system regarding initial process for identifying potential candidates and eligibility of SSDI;

FIG. 4 is a flow diagram of a process executed to provide the interface using a display for a network administrator system regarding periodic reviews and updates of existing records within the automated database;

FIG. 5 is a flow diagram of a process executed identifying persons who are potentially eligible for Social Security Disability Insurance in accordance with the invention;

FIG. 6 is a flow diagram of a process executed for determining Social Security Disability Insurance eligibility in accordance with the invention;

FIG. 7 is a flow diagram of a process executed for determining Social Security Disability Insurance for a person with a developmental disability based on parental qualifications;

FIG. 8 is a flow diagram of a process executed for determining Social Security Disability Insurance for a person with a mental illness based on parental qualifications;

FIG. 9 is a flow diagram of a process for determining Social Security Disability Insurance for a person with a mental illness based on marital qualifications;

FIG. 10 is a flow diagram of a process executed for periodically reviewing and updating parental data pertaining to Social Security Disability Insurance in accordance with the present invention;

FIG. 11 is a flow diagram of a process executed for periodically reviewing and updating marital data pertaining to Social Security Disability Insurance in accordance with present invention;

FIG. 12 is a flow diagram of a process for subsequently reviewing Social Security Disability Insurance eligibility for persons having a developmental disability or mental illness based on parental qualifications;

FIG. 13 is a flow diagram of a process executed for subsequently reviewing Social Security Disability Insurance eligibility for persons having a mental illness based on marital qualifications; and

FIG. 14 is a flow diagram of a process executed for identifying issued lump sum Social Security Disability Insurance payments.

### DESCRIPTION

Referring now to the drawings wherein the showings are only for purposes of illustrating a preferred version of the invention and not for purposes of limiting the same. The disclosure of U.S. Provisional Patent Application No. 61/944,685 is hereby incorporated in its entirety.

The following description of exemplary embodiments of the invention is not intended to limit the scope of the invention to these exemplary embodiments, but rather to enable any person skilled in the art to make and use the invention.

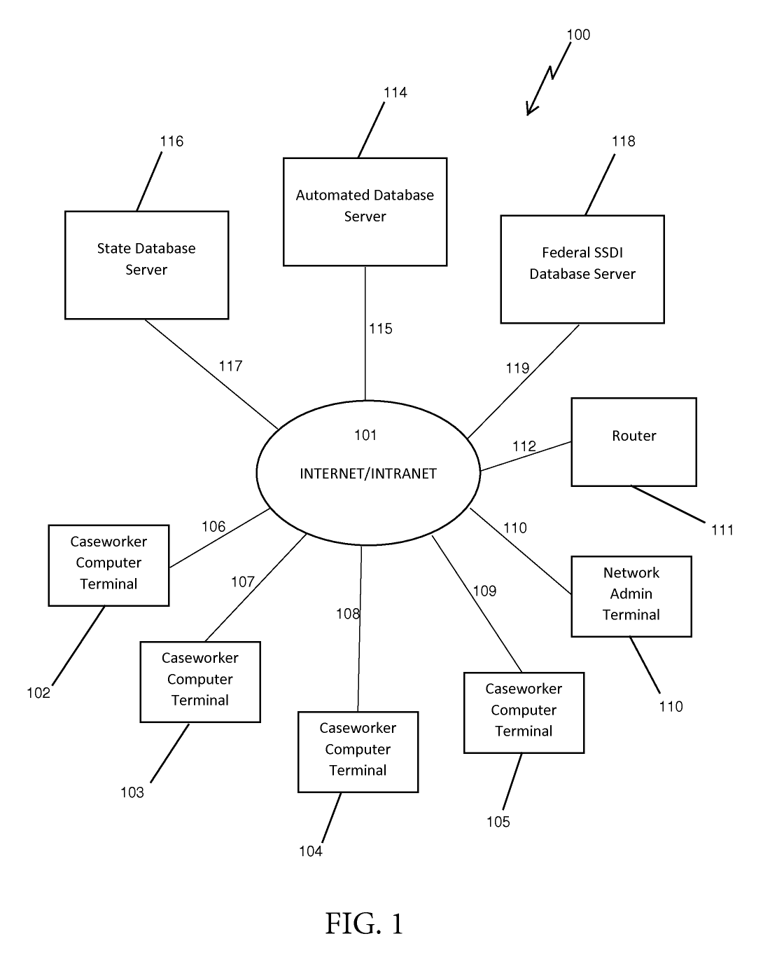

FIG. 1 illustrates a network 100 that provides a system for automated Social Security eligibility in accordance with this invention. Network 100 includes Internet or Intranet 101 that connects various processing systems in network 100 to allow the exchange of data between the processing systems. One skilled in the art will recognize that processing systems are personal computers, system computers, routers, or other devices that can process digital data.

In network 100, processing systems or caseworker computer terminals 102-105 are connected to Internet/Intranet 101 via paths 106-109. One skilled in the art will recognize that paths 106-109 may be telephone line, Ethernet lines, a wireless connection or any other manner of connecting processing systems. One skilled in the art will also recognize that any number of processing systems may be connected to Internet/Intranet 101.

In network 100, system administration terminal 110 is connected to the Internet/intranet via path 120. The system administration terminal 110 is utilized to oversee the operation of the invention.

Router 111 or other processing device is connected to the Internet/Intranet 101 via path 112 which controls data transfers between processing systems connected to Internet/Intranet 101.

Automated database server 114 is connected to Internet/Intranet 101 via path 115. The automated database server 114 is a processing system that maintains databases that contain records that are created and accessed by this invention. The automated database server 114 stores information relating to SSDI status and qualifications for persons in the form of a record. The database records may include information indicating whether persons are classified as receiving SSDI, persons that are potentially eligible for persons that are eligible for SSDI, and persons who are disqualified from receiving SSDI. The database can be searchable by any number of criteria such as by identifying information including name, address, age, name and social security number as well as status of SSDI and parental information relating to persons eligible for SSDI.

State database server 116 is connected to Intranet/Internet 101 via path 117. State database server 116 is connected to Internet/Intranet 101 via path 117. State database server 116 provide records and information relating to persons receiving treatment for developmental disabilities and/or mental illness from a State licensed care facility. The State database server may be existing servers currently in use by the State or a server that is developed in order to carry out the invention.

The Federal Social Security database server 118 is connected to Internet/Intranet 101 via path 119. The Federal Social Security database server is a processing system that maintains databases relating to persons status of SSDI, and parental and marital information relating to SSDI

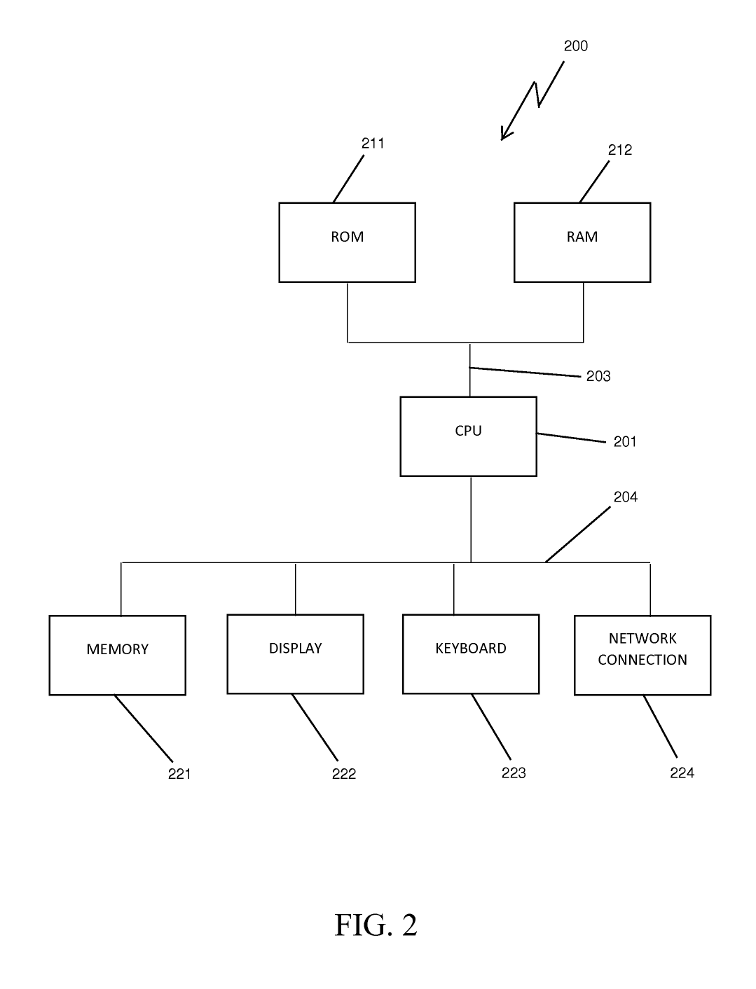

FIG. 2 illustrates an exemplary embodiment of a processing system 200. One skilled in the art will recognize that each device connected to network 100 in FIG. 1 includes a processing system. However, exact configuration and device connected to the processing system in each individual device in the network may vary.

It should be understood that the calculations may be performed by any suitable computer system, such as the one shown in FIG. 2. Processing system 200 has a Central Processing Unit (CPU) 201, CPU 201 is a processor, microprocessor, or any combination of processors and microprocessor that execute instructions stored in memory to perform an application. CPU 201 is connected to a memory bus 203 and Input/Output (I/O) bus 204.

A non-volatile memory, such as Read Only Memory (ROM) 211, is connected to CPU 201 via memory bus 203. ROM 211 stores instructions for initialization and other system commands of processing system 200. One skilled in the art will recognize that any memory that can be written to by CPU 201 may be used for the functions of ROM 211.

A volatile memory such as Random Access Memory (RAM) 212 is also connected to CPU 201 via memory bus 204. RAM 212 stores instructions for all processes being executed and data operated upon by the executed processes. One skilled in the art will recognize that other types of memories such DRAM and SRAM may also be used as a volatile memory and that memory caches and other memory devices (Not shown) may be connected to memory bus 204.

Peripheral devices including, but not limited to, memory 221, display 222, I/O device 223, and network connection device 224 that are connected to CPU 201 via I/O bus 204. I/O bus 204 carries data between the device and CPU 201. Memory 221 is a device for storing data. Some examples of memory 221 include read/write compact discs (CDs), and magnetic disk drives. Display 222 is a monitor or display and associated drivers that convert data to a display. I/O device 223 is a keyboard, a pointing device or other device that may be used by a user to input data, Network device 224 is a modem or Ethernet “card” that connects processing system 200 to a network. One skilled in the art will recognize that exact configuration and devices connected to each processing system in network 100 may vary depending upon the operations that the processing system performs in the network.

The present invention relates to a computerized method and system for determining the eligibility for social security disability insurance benefits through a computer network which is automated. In accordance with this invention, an interface is provided that may access the databases needed by a caseworker in order to determine whether a person is eligible for SSDI. The interface may be provided by software executed by a processing system at a work station, such as a desktop or laptop computer, or may be executed by a server that is in communication with a workstation over a network using a browser or other access software.

When an assigned caseworker or network administrator logs into the system, the interface provides a display that will provide the caseworker or administrator with the options available by the interface to the caseworker or administrator. Preferably, the display is a “Windows” type display with activation “buttons” for each option. The user can then select an option by “clicking” on the activation button for the option using a pointing device such as a mouse. Alternatively, the interface may have various drop down menus that may be scrolled through to select an option and may utilize data entry fields in order to carry out the processes described below.

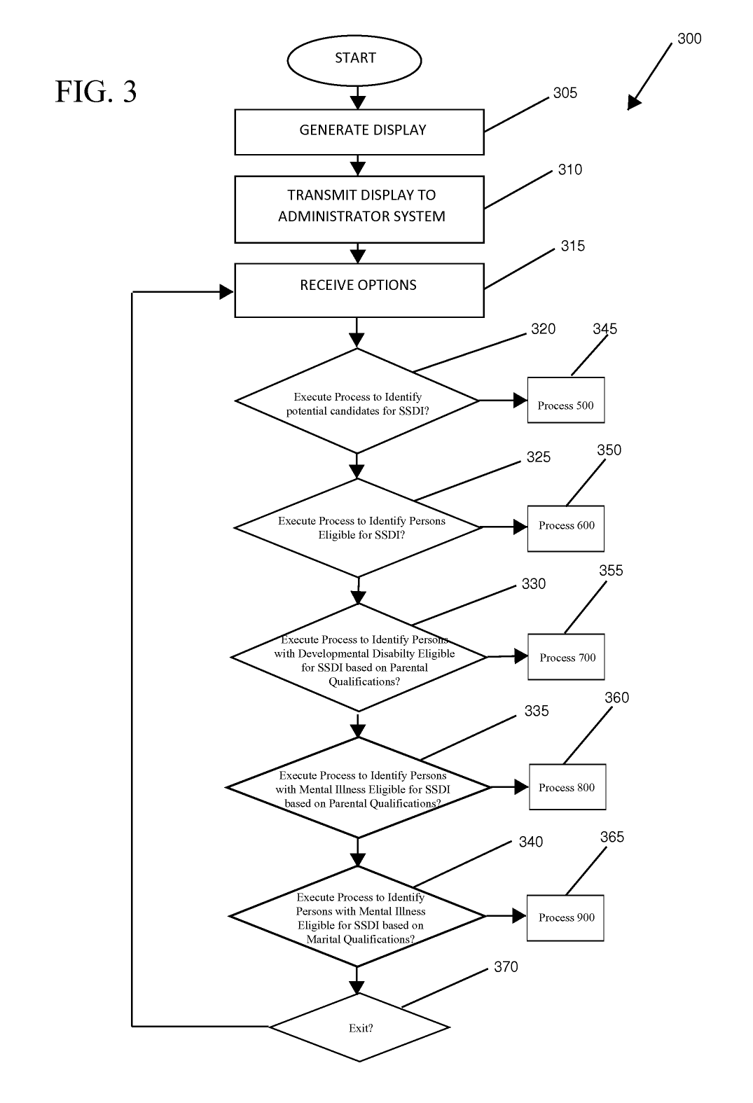

FIG. 3 illustrates an example flow diagram of a process 300 executed to provide a basic interface regarding system administrator execution of processes relating to initial determination of potential eligibility and current eligibility of SSDI using the above described display. Process 300 begins in step 305 in which the display is generated by the processing unit in the processing system executing process 300. In step 310, the display is then transmitted. If the processing system is accessing process 300 via a network connection, the processing system executing process 300 transmits the display to the workstation of the network administrator. Otherwise, the display is transmitted to the display device of the processing system. One skilled in the art will recognize that different instructions are needed to generate the display depending on which device receives the display.

In step 315, process 300 receives a request for an option to be performed. The option may either be received as a request from a workstation or as an input into the processing system depending upon how the interface is being executed. For example, the request may be a “click” on a “button” of the screen if the processing system is directly performing the process or a request message generated by a workstation in response to a click on a button on the display of the workstation if a workstation is connected to the processing system executing process 300.

In step 320, process 300 determines whether a request to execute the process to identify potential candidates for SSDI was received. If the request to execute is received, process 500 is performed in step 345 and then process 300 returns to step 315 to receive another option. Otherwise, process 300 continues to step 325.

In step 325, process 300 determines whether a request to execute the process to identify persons eligible for SSDI was received. If the request to execute is received, process 600 is performed in step 350 and then process 300 returns to step 315 to receive another option. Otherwise, process 300 continues to step 330.

In step 330, process 300 determines whether a request to execute the process to identify persons with developmental disability eligibility for SSDI based on parental qualifications was received. If the request to execute is received, process 700 is performed in step 355 and then process 300 returns to step 315 to receive another option. Otherwise, process 300 continues to step 335.

In step 335, process 300 determines whether a request to execute the process to identify persons with mental illness eligibility for SSDI based on parental qualifications was received. If the request to execute is received, process 800 is performed in step 360 and then process 300 returns to step 315 to receive another option. Otherwise, process 300 continues to step 340.

In step 340, process 300 determines whether a request to execute the process to identify persons with mental illness eligibility based on marital qualifications was received. If the request to execute is received, process 900 is performed in step 365 and then process 300 returns to step 315 to receive another option. Otherwise, process 300 continues to step 370.

In step 370, process 300 determines whether a quit or exit command is received. If a quit request is received process 300 ends. Otherwise process 300 returns to 315 to receive another option.

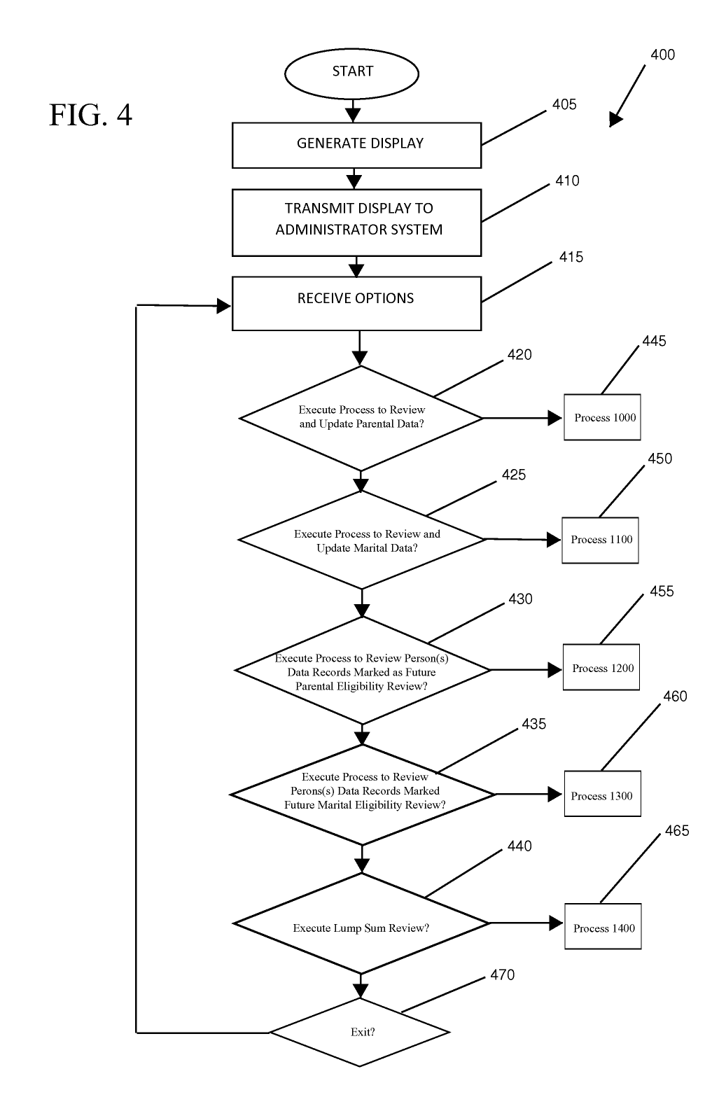

FIG. 4 illustrates an example flow diagram of a process 400 executed to provide a basic interface regarding system administrator execution of processes relating to review and update of database records concerning persons potentially eligible for SSDI. Process 400 begins in step 405 in which the display is generated by the processing unit in the processing system executing process 400. In step 410, the display is then transmitted. If the processing system is accessing process 400 via a network connection, the processing system executing process 400 transmits the display to the workstation of the network administrator. Otherwise, the display is transmitted to the display device of the processing system. One skilled in the art will recognize that different instructions are needed to generate the display depending on which device receives the display.

In step 415, process 400 receives a request for an option to be performed. The option may either be received as a request from a workstation or as an input into the processing system depending upon how the interface is being executed. For example, the request may be a “click” on a “button” of the screen if the processing system is directly performing the process or a request message generated by a workstation in response to a click on a button on the display of the workstation if a workstation is connected to the processing system executing process 400.

In step 420, process 400 determines whether a request to execute the process to review and update parental data was received. If the request to execute is received, process 1000 is performed in step 445 and then process 400 returns to step 415 to receive another option. Otherwise, process 400 continues to step 425.

In step 425, process 400 determines whether a request to execute the process to review and update marital data was received. If the request to execute is received, process 1100 is performed in step 450 and then process 400 returns to step 415 to receive another option. Otherwise, process 400 continues to step 430.

In step 430, process 400 determines whether a request to execute the process to review person(s) data records marked as future parental eligibility review was received. If the request to execute is received, process 1200 is performed in step 455 and then process 400 returns to step 415 to receive another option. Otherwise, process 400 continues to step 435.

In step 435, process 400 determines whether a request to execute the process to review person(s) data records marked future marital eligibility review was received. If the request to execute is received, process 1300 is performed in step 460 and then process 400 returns to step 415 to receive another option. Otherwise, process 400 continues to step 440.

In step 440, process 400 determines whether a request to execute the process to review lump sum payments was received. If the request to execute is received, process 1400 is performed in step 465 and then process 400 returns to step 415 to receive another option. Otherwise, process 400 continues to step 470.

In step 470, process 400 determines whether a quit or exit command is received. If a quit request is received process 400 ends. Otherwise process 400 returns to 415 to receive another option.

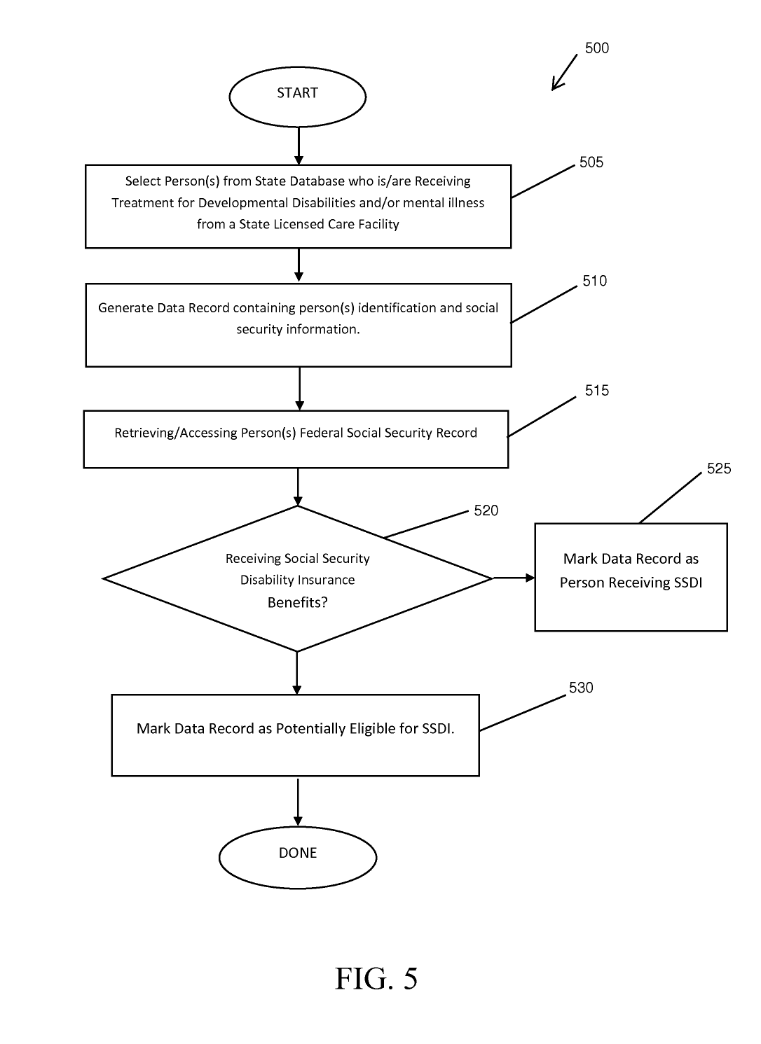

FIG. 5 illustrates a flow diagram of the overall process 500 executed in order to identify potential candidates for SSDI. The process 500 can be initiated by the system administrator or programmed to be executed periodically at desired intervals of time. Process 500 begins in step 505 by selecting at least one person from the State database found on the State database server 116 who is determined to be receiving treatment for developmental disabilities in accordance with State law. In step 510, an electronic data record is created containing relevant information regarding the selected person's identity and SSDI related information. More particularly, the electronic data record contains information relating to at least the identity of the selected person and social security number. The electronic data record is recorded on the automated database server 114 or a computer readable media. Next, in step 515, the person's Federal Social Security record containing information relating to the person's status of SSDI benefits is accessed via the network from the Federal Social Security database server 118. In step 520, process 500 determines whether the selected person is either receiving SSDI or not receiving SSDI based on the SSDI status information contained within the Federal Social Security database record through the computer network. The determination is programmed to be automatically determined by the system. If the person is determined to be receiving SSDI, the person's data record is marked indicating that they are receiving SSDI as shown in step 525. If the person is determined not to be receiving SSDI, the data record is marked as being potentially eligible for SSDI as shown in step 530.

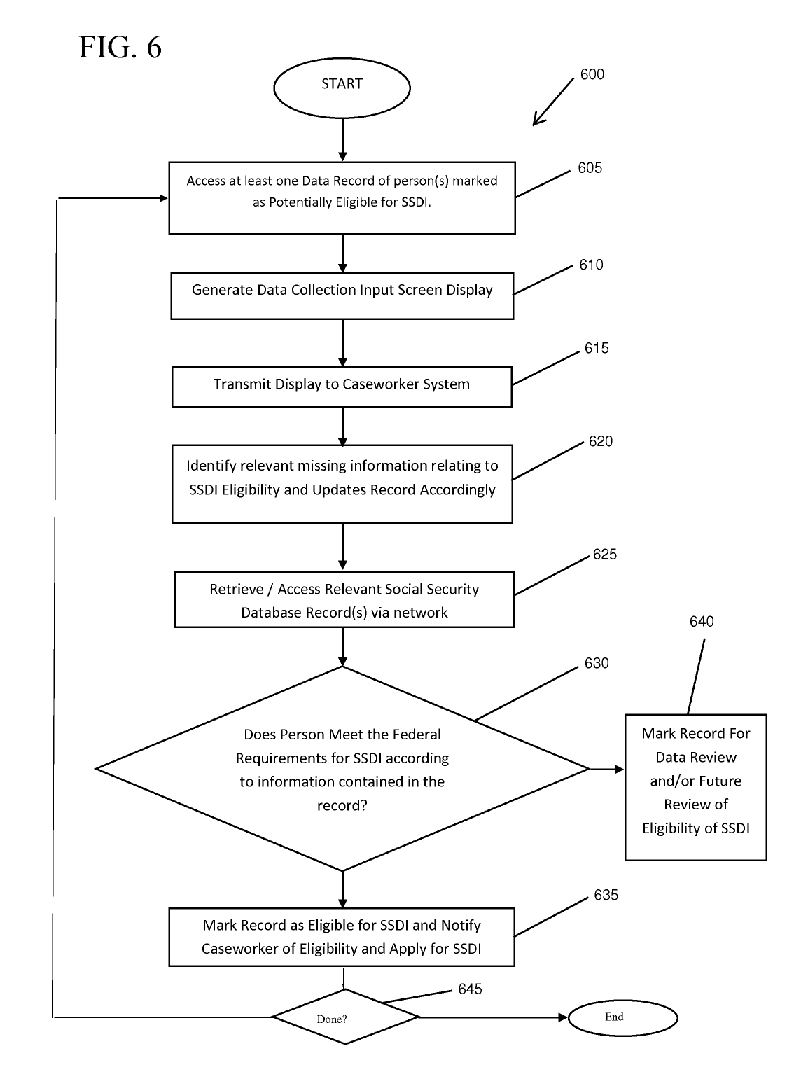

FIG. 6 illustrates a flow diagram of the overall process 600 executed in order to identify persons that are eligible to receive SSDI. Process 600 begins in step 605 by accessing at least one data record of persons indicated as not receiving SSDI benefits and therefore are potentially eligible for SSDI benefits. A data collection screen 610 is generated and is transmitted to caseworker system 615. In step 620, caseworker identifies required information in order to qualify for SSDI benefits and updates the person's data record via the data collection input screen. The data collection screen can be in any form that allows the caseworker to directly input information into the system. For example, data fields can be utilized which allows the caseworker to directly input the information into the system via the keyboard 223.

The SSDI eligibility requirements may change overtime; however, general identified information for determining eligibility would be date of disability, current social security benefit status of parents if retired, whether parents are deceased or disabled, current social security benefit status of spouse if retired, and/or whether spouse is deceased or disabled.

This information can be obtained via paper or electronic survey of the person, by the caseworker through direct contact with the person, through investigative research, or by any other legal means of obtaining the information. Moreover, this information may be obtained by accessing government records such as records contained within the State Bureau of Motor Vehicles and the Federal Social Security Database.

In order to retrieve parental and/or marital Federal Social Security records containing information for determining eligibility of SSDI benefits based on parental and/or marital requirements, parental and/or marital names and Social Security numbers of the person must be identified by the data collection processes described above. Once identified, the identified available parental and/or marital names and Social Security numbers are input into the person's electronic data record. In step 625, the process 600 retrieves the parental and/or marital Social Security record(s) from the Federal Social Security database through the computer network in order to identify information for determining eligibility for SSDI benefits.

It shall be known that the process can be programmed to automatically identify available information from any available resource as well as programmed to automatically input the identified information into the electronic data record. Therefore, bypassing the need for manually identifying available relevant information and manually inputting the information into the person's electronic data record.

Once all available information is collected and the persons record has been updated, process 600 determines in step 630 whether the person is eligible for receiving SSDI benefits based on the identified information for determining eligibility of SSDI benefits contained in the person's data record and current SSDI benefit law and legal requirements. If the persons is determined to be eligible for SSDI benefits, in step 635 the person is indicated within the record that they are eligible for SSDI benefits or they do are not eligible for SSDI benefits. A caseworker is then notified that the person is eligible SSDI benefits. In turn, the caseworker applies for SSDI benefits on behalf of the eligible person.

If it is determined in step 630 that person is not eligible for SSDI based on the information contained in the person's record, the person's record is marked for future data review and/or for future review of eligibility of SSDI as further described in detail below as showed in step 640.

In step 645, process 600 determines whether a quit or exit command is received. If a quit request is received process 600 ends. Otherwise process 600 returns to 605 to access another data record of person(s) marked as potentially eligible for SSDI.

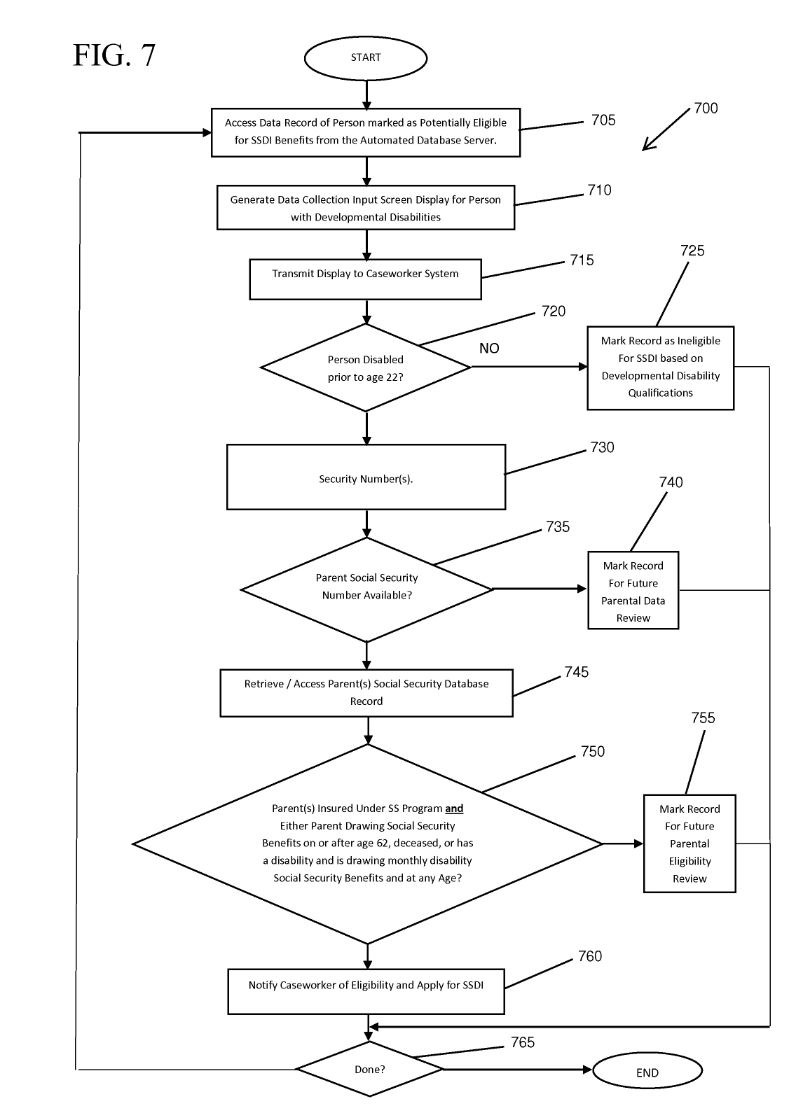

FIG. 7 illustrates a flow diagram of the process 700 executed for determining Social Security Disability Insurance for a person with a developmental disability based on parental qualifications.

In order for a person with a developmental disability to be eligible for SSDI, parent(s) are required to be insured under the federal Social Security program and either parent drawing Social Security benefits on or after the age of 62, deceased, or has a disability and is drawing monthly disability Social Security benefits at any age.

Process 700 begins in step 705, by accessing at least one electronic data record of persons marked as potentially eligible for SSDI from the automated database server 114. A data collection input screen 710 is generated and is transmitted to caseworker system display 715. In step 720, process 700 determines if the person was disabled prior to the age of 22 based on the information currently found in the person's file or by determination by the caseworker through investigation. The record should be updated by the caseworker to reflect the age at which person's became disabled via the data collection input screen. If it is determined that the person did not become disabled prior to the age of 22, in step 725, the person's record is marked as ineligible for SSDI based on developmental disability qualifications and continues to step 765. Otherwise, in step 730, the case worker is prompted to identify relevant missing information relating to parental names and Social Security numbers of the person identified in the data record.

In step 735, process 700 determines whether one or both of the parental Social Security numbers is/are available. If one or both of the parental Social Security numbers are available, process 700 retrieves one or both of parental Federal Social Security records via the network from the Federal SSDI Database 118 server in step 745. Otherwise, process 700 marks the record for future parental data review in step 740.

Once all currently available information is collected and the person's data record has been updated, process 700 determines in step 750 whether the person currently qualifies for SSDI based on the identified information contained in the person's record and SSDI law. If the persons is determined to be qualify for SSDI, process 700 marks the person's record as eligible for SSDI and is put in queue in order for a case worker to apply for SSDI on the person's behalf in step 760

If it is determined in step 750 that person is not eligible for SSDI based on the information contained in the person's record, process 700 in step 755 marks the record for future parental eligibility review of SSDI.

In step 765, process 700 determines whether a quit or exit command is received. If a quit request is received process 700 ends. Otherwise process 700 returns to 705 to access another data record of person marked as potentially eligible for SSDI benefits.

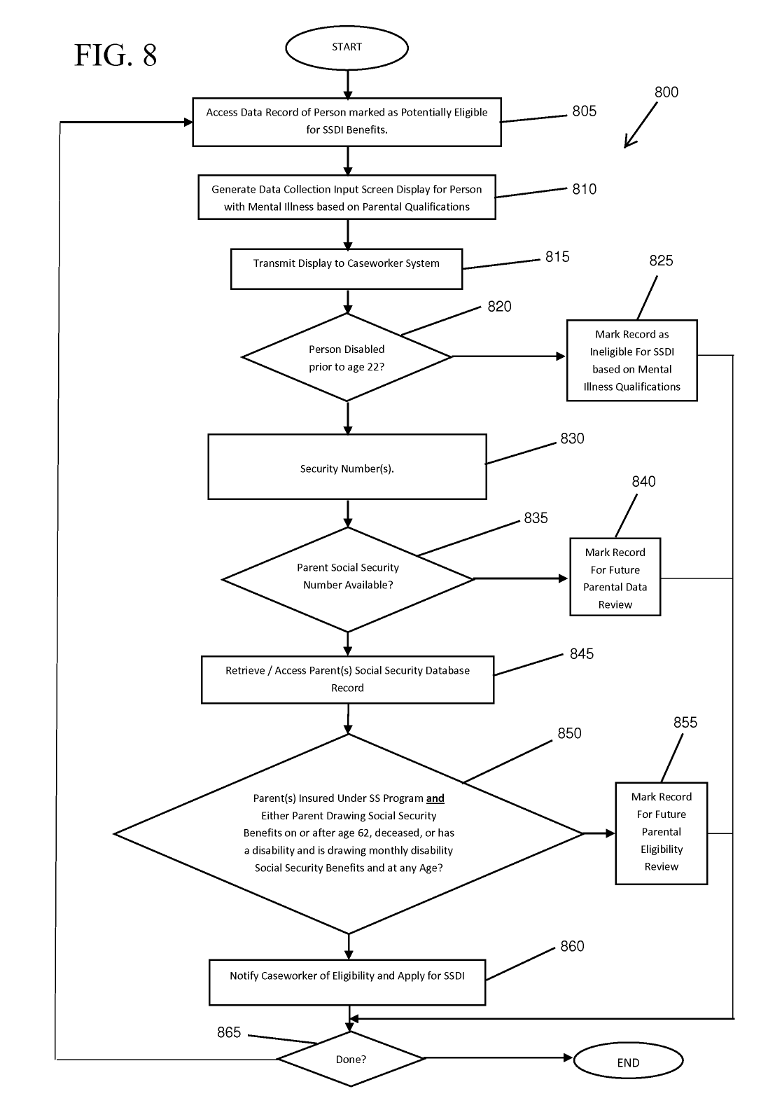

FIG. 8 illustrates a flow diagram of the process 800 executed for determining Social Security Disability Insurance for a person with a mental illness based on parental qualifications.

In order for the person will mental illness to be eligible for SSDI, parent(s) are required to be insured under the federal Social Security program and either parent drawing social security benefits on or after the age of 62, deceased, or has a disability and is drawing monthly disability social security benefits at any age.

Process 800 begins in step 805, by accessing at least one data record of persons marked as potentially eligible for social security benefits. A data collection input screen 810 is generated and is transmitted to caseworker system display 815. In step 820, process 800 determines if the person was disabled prior to the age of 22 based on the information currently found in the person's file or by determination by the caseworker through investigation. The record should be updated by the caseworker to reflect the age at which person's became disabled via the data collection input screen. If it is determined that the person did not become disabled prior to the age of 22, in step 825, the person's record is marked as ineligible for SSDI based on mental illness qualifications and continues to step 865. Otherwise, in step 830, the case worker is prompted to identify and enter relevant missing information relating to parental names and Social Security numbers of the person identified in the data record.

In step 835, process 800 determines whether one or both of the parental Social Security numbers is/are available. If one or both of the parental social security numbers are available, process 800 retrieves one or both of their Federal Social Security records via the network from the Federal SSDI Database server in step 845. Otherwise, process 800 marks the record for future parental data review in step 840.

Once all available information is collected and the persons record has been updated, process 800 determines in step 850 whether the person is currently eligible for SSDI based on the information contained in the person's data record and the requirements of SSDI. If the persons is determined to be eligible for SSDI, process 800 marks the person's record as eligible for SSDI and is put in queue in order for a case worker to apply for SSDI on the person's behalf in step 860.

If it is determined in step 850 that the person is not eligible for SSDI based on the information contained in the person's data record, process 800 marks the record for future parental eligibility review as shown in step 855.

In step 865, process 800 determines whether a quit or exit command is received. If a quit request is received process 800 ends. Otherwise process 800 returns to 805 to access another data record of person marked as potentially eligible for SSDI benefits.

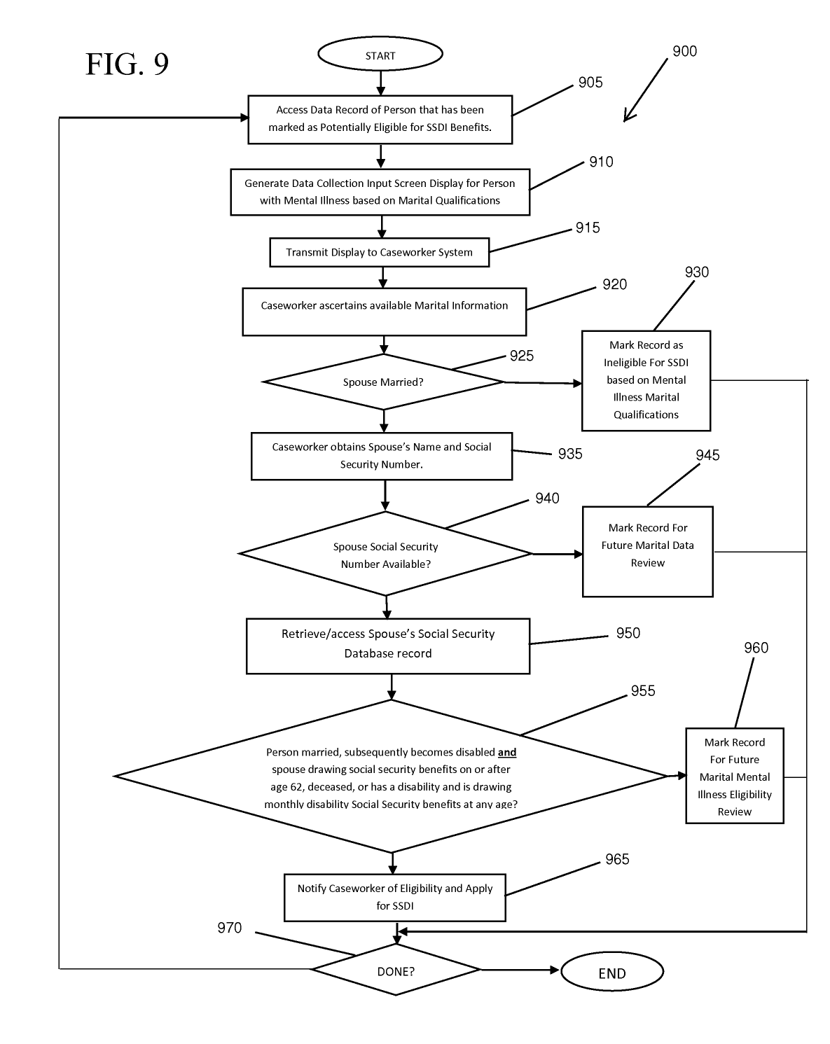

FIG. 9 illustrates a flow diagram of the process 900 executed for determining Social Security Disability Insurance for a person with a mental illness based on marital qualifications.

In order for the person with mental illness to be eligible for SSDI based on marital qualifications, the person must be married and subsequently becomes disabled because of a mental illness and the spouse must be drawing Social Security benefits on or after the age of 62, deceased, or has a disability and is drawing monthly disability Social Security benefits at any age.

Process 900 begins in step 905, by accessing at least one data record of persons that have been classified as potentially eligible for Social Security benefits. A data collection input screen 910 is generated and is transmitted to caseworker system display 915. In step 920, the case worker is prompted to identify whether person is currently married and enter this information into the record via the date collection input screen. In step 925, process 900 determines whether the person is married based on the information contained in the record. If the person is married, process 900 prompts the caseworker to identify spouse's name and Social Security number by further investigation in step 935. Otherwise, process 900 marks the record as ineligible for SSDI based on mental illness marital qualifications as shown in step 930.

In step 940, process 900 determines whether the spouse's Social Security number is available. If the spouse's Social Security number is available, process 900 retrieves spouse's Federal Social Security record via the network from the Federal SSDI database server 118 in step 950. Otherwise, process 900 marks the record for future marital data review in step 945.

Once all available information is collected and the persons record has been updated, process 900 determines in step 955 whether the person is currently eligible for SSDI based on the information contained in the person's record and the requirements of SSDI. If the persons is determined to be eligible for SSDI, process 900 marks the person's record as eligible for SSDI and is put in queue in order for a case worker to apply for SSDI on the person's behalf in step 965.

If process 900 in step 955 determines that a person is not eligible for SSDI based on the information contained in the person's record, process 900 marks the record for future marital mental illness eligibility review in step 960 and continues with step 970.

In step 970, process 900 determines whether a quit or exit command is received. If a quit request is received process 900 ends. Otherwise process 900 returns to 905 to access another data record of person marked as potentially eligible for SSDI benefits.

After the initial review of SSDI eligibility, persons data records who did not qualify for SSDI are maintained for future review of eligibility or for future review of information that previously could not be ascertained as in step 640 of process 600. These records are periodically reviewed in order to determine SSDI eligibility. The frequency of the review process is determined by the system administrator.

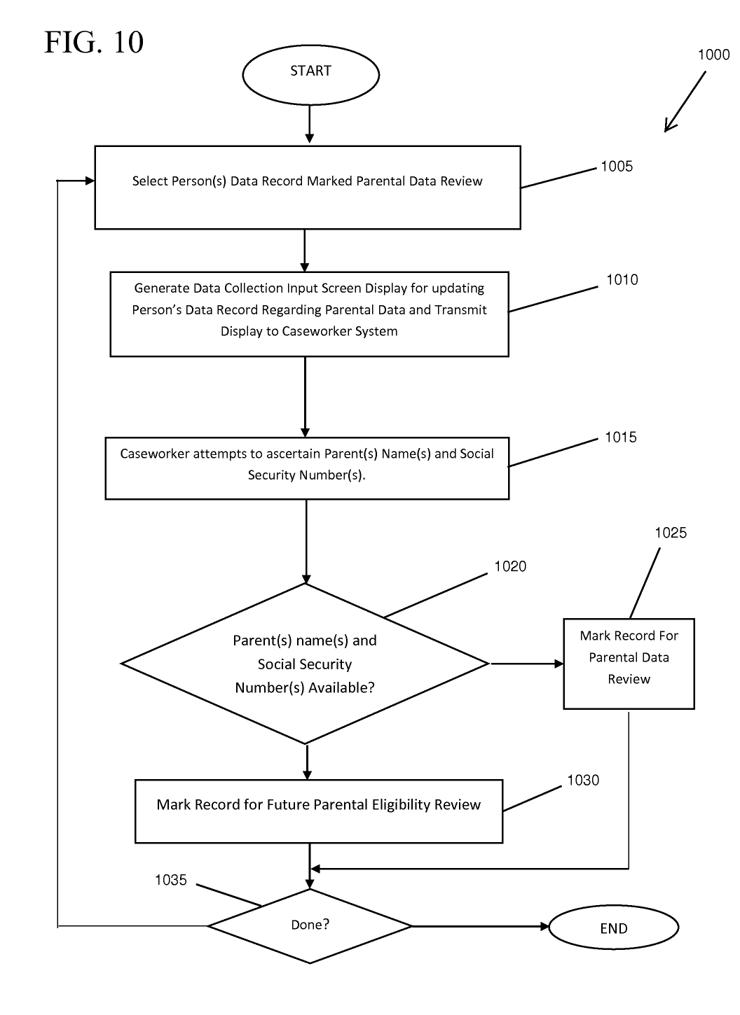

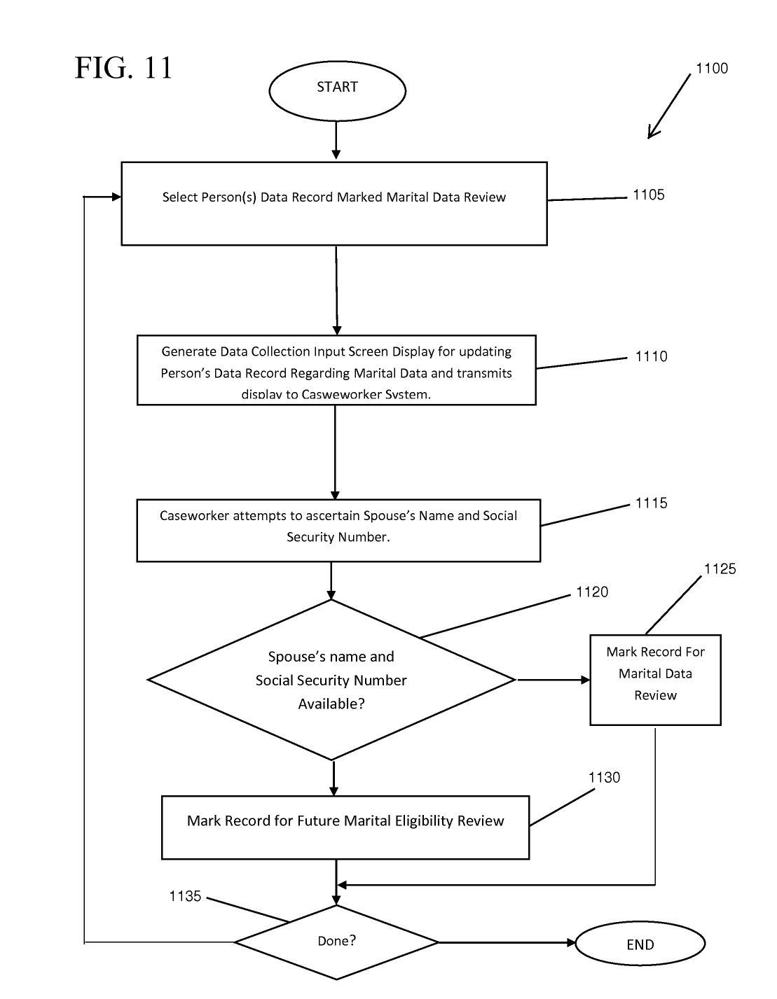

FIG. 10 and FIG. 11 illustrate the detailed process of reviewing and updating data records that were previously marked as future parental data review or future marital data review.

FIG. 10 illustrates a flow diagram of the process 1000 executed to review person(s) data record marked for future parental data review. Process 1000 begins in step 1005, by accessing person(s) data record marked parental data review. In step 1010, a data collection screen is generated and transmitted to caseworker system. In step 1015, the caseworker is prompted to identify relevant missing information relating to parental names and Social Security numbers.

In step 1020, process 1000 determines whether one or both of the parental Social Security numbers is/are available. If one or both of the parental Social Security numbers are available, process 1000 marks the data record for future parental eligibility review in step 1030. Otherwise, process 1000 marks the record for future parental data review in step 1025.

In step 1035, process 1000 determines whether a quit or exit command is received. If a quit request is received process 1000 ends. Otherwise process 1000 returns to 1005 to access another data record of person marked for parental data review.

FIG. 11 illustrates a flow diagram of the process 1100 executed to review person(s) data record marked for future marital data review. Process 1100 begins in step 1105, by accessing person(s) data record marked marital data review. In step 1110, a data collection screen is generated and transmitted to caseworker system. In step 1115, the caseworker is prompted to identify relevant missing information relating to spouse's name and Social Security number.

In step 1120, process 1100 determines whether persons spouse is available. If spouse's Social Security numbers is available, process 1100 marks the data record for future marital eligibility review in step 1130. Otherwise, process 1100 marks the record for future marital data review in step 1125.

In step 1135, process 1100 determines whether a quit or exit command is received. If a quit request is received process 1100 ends. Otherwise process 1100 returns to 1105 to access another data record of person marked for marital data review.

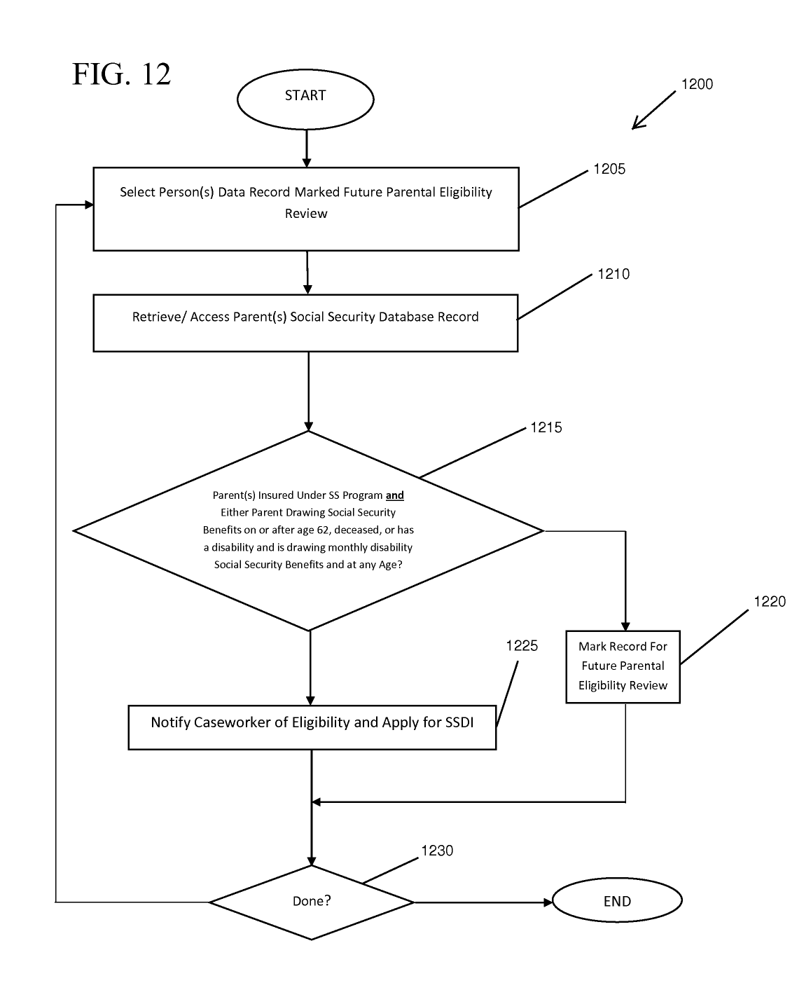

FIG. 12 illustrates a flow diagram of the process 1200 executed for reviewing person(s) data record marked for future parental eligibility review for either a developmental disability or mental illness for determining Social Security Disability Insurance for a person with a developmental disability or mental illness based on parental qualifications.

Process 1200 begins in step 1205, by accessing person(s) data record marked future parental eligibility review. After the data record is retrieved, process 1200 retrieves the parent(s) federal Social Security record via the network from the Federal SSDI database server 118 based on the parental information contained within the person's data file.

Once the parental Social Security file(s) are accessed, process 1200 determines in step 1215 whether the person is currently eligible for SSDI based on the information contained in the parent(s) Social Security file and the persons data record. If the person(s) is/are determined to be eligible for SSDI, process 1200 marks the person's record as eligible for SSDI and is put in queue in order for a case worker to apply for SSDI on the person's behalf in step 1225.

If it is determined in step 1215 that person is not currently eligible for SSDI based on the information contained in the person's record, process 1200 in step 1220 marks the record for future parental eligibility review.

In step 1230, process 1200 determines whether a quit or exit command is received. If a quit request is received process 1200 ends. Otherwise process 1200 returns to 1205 to access another data record of person marked as future parental eligibility review.

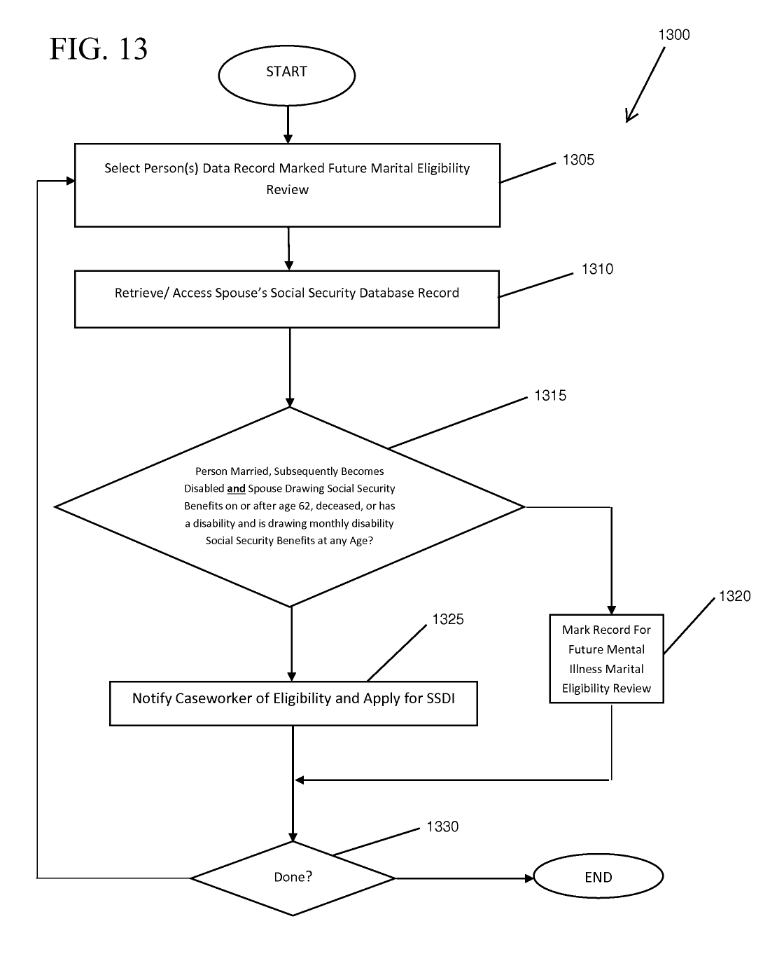

FIG. 13 illustrates a flow diagram of the process 1300 executed for reviewing person(s) data record marked for future marital eligibility review for a mental illness for determining SSDI for a person with a mental illness based on marital qualifications.

Process 1300 begins in step 1305, by accessing person(s) data record marked future marital eligibility review. After the data record is retrieved, process 1300 retrieves the spouse's Federal Social Security record via the network from the Federal SSDI database server 118 based on the parental information contained within the person's data file shown in step 1310.

Once the spouse's federal Social Security records are obtained, process 1300 determines in step 1315 whether the person is currently eligible for SSDI based on the information contained in the spouse's Federal Social Security record and the person's data record. If the persons is determined to be eligible for SSDI, process 1300 marks the person's record as eligible for SSDI and is put in queue in order for a case worker to apply for SSDI on the person's behalf in step 1325.

If it is determined in step 1325 that the person is not currently eligible for SSDI based on the information contained in the person's record, process 1300 in step 1320 marks the record for future marital eligibility review.

In step 1330, process 1300 determines whether a quit or exit command is received. If a quit request is received process 1300 ends. Otherwise process 1300 returns to 1305 to access another data record of person marked as future marital eligibility review.

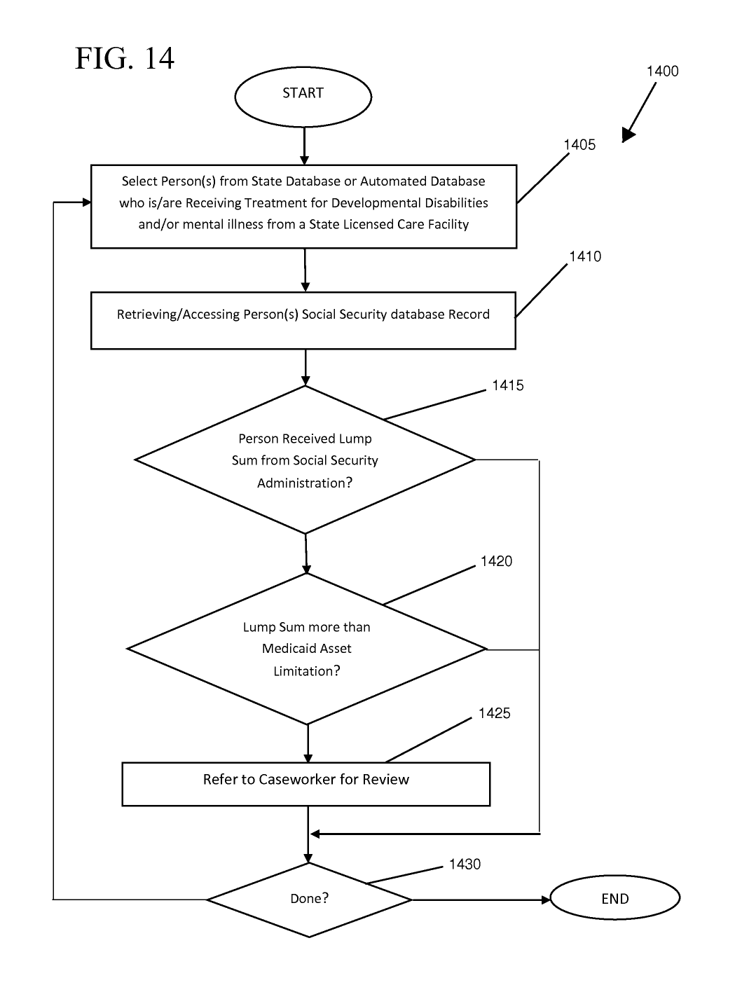

FIG. 14 illustrates a flow diagram of the process 1400 executed to review person(s) who are receiving treatment from a state licensed care facility who may have received money from the Social Security Administration in the form of a lump sum payment. In this situation the lump sum payment would be reviewed for appropriate disposition under the Medicaid regulations.

Process 1400 begins in step 1405 by selecting at least one person from the State database found on the state database server 116 or from a previously created record stored on the automated database on the automated database server 114 who is determined to be receiving treatment for a developmental disability and/or mental illness from a State licensed care facility.

In step 1410, process 1400 access the person's Federal Social Security record via the network from the Federal Social Security database server 118. In step 1415, process 1400 determines whether the person has received a lump sum from the Social Security Administration. If the person is determined to have received a lump sum, process 1400, in step 1420 determines whether the amount of the lump sum exceeds the Medicaid Asset Limitation. If the amount exceeds the limitation, the data record is marked to be reviewed by a Caseworker as shown in step 1425. However, a lump sum was not paid out by the Social Security Administration or the amount did not exceed the Medicaid Asset Limitation, process 1400 moves on to step 1430.

In step 1430, process 1400 determines whether a quit or exit command is received. If a quit request is received process 1400 ends. Otherwise process 1400 returns to 1405 to select another person from the State Database or an existing person record from the Automated Database for review relating to lump sum payments.

The present invention has many significant advantages. The invention substantially saves Federal and State governments funds by utilizing the inventive process, which substantially increases efficiency and mitigates the time involved with determining SSDI benefits. Current processes are inefficient and time consuming, typically requiring personnel to work within a uninformed, manual environment allowing eligible SSDI benefits to be overlooked.

Moreover, after the requisite data has been entered into the system, the automated system seamlessly carries out the process of determining who is eligible for SSDI and who is not, which frees up assigned staff to perform more traditional duties.

Additionally, the invention can immediately and efficiently search through electronic data records based on a desired parameters such as by age or by treatment facility and has the ability to compile data reports.

Another additional advantage of the system and method is that no consent forms for data collection and cross matching are needed because the authority is previously established at both the Federal and State level and extended statewide to local authorities. Current procedure requires consent forms because there is no uniformed process in place.

It shall be known that all the advantageous features and/or advantages do not need to be incorporated into every version of the invention.

Although preferred versions of the invention have been described in considerable detail, other versions of the invention are possible.

All the features disclosed in this specification (including and accompanying claims, abstract, and drawings) may be replaced by alternative features serving the same, equivalent or similar purpose unless expressly stated otherwise. Thus, unless stated otherwise, each feature disclosed is one example only of a generic series of equivalent or similar features.

What is claimed is:

1. A computerized method for determining eligibility for social security disability insurance (SSDI) benefits through a computer network, comprising the steps of:
(a) providing a computer processing means and a computer readable media;
(b) providing access to a Federal Social Security database through the computer network, wherein the Federal Social Security database provides records containing information relating to a person's status of SSDI and/or parental and/or marital information relating to SSDI benefit eligibility;
(c) selecting at least one person who is identified as receiving treatment for developmental disabilities and/or mental illness;
(d) creating an electronic data record comprising information relating to at least the identity of the person and social security number, wherein the electronic data record is recorded on the computer readable media;
(e) retrieving the person's Federal Social Security record containing information relating to the person's status of SSDI benefits;
(f) determining whether the person is receiving SSDI benefits based on the SSDI status information contained within the Federal Social Security database record through the computer network; and
(g) indicating in the electronic data record whether the person is receiving SSDI benefits or is not receiving SSDI benefits.

2. The computerized method for determining eligibility for social security disability insurance benefits through a computer network as recited in claim 1, further comprising providing access to a State database through the network, wherein the State database provides records containing information relating to persons receiving treatment for developmental disabilities and/or mental illness from a State licensed care facility, and wherein the step of selecting the at least one person who is identified as receiving treatment for developmental disabilities and/or mental illness is selected from the State database.

3. The computerized method for determining eligibility for social security disability insurance benefits through a computer network as recited in claim 1, further comprising determining whether the person indicated as not receiving SSDI benefits is eligible for receiving SSDI benefits based on current SSDI benefit legal requirements.

4. The computerized method for determining eligibility for social security disability insurance benefits through a computer network as recited in claim 1, further comprising the steps performed, for at least one electronic data record of persons indicated as not receiving SSDI benefits, of:
(a) identifying available parental and/or marital names and Social Security numbers of the person indicated in the electronic data record as not receiving SSDI benefits;
(b) inputting into the electronic data record identified available parental and/or marital names and Social Security numbers;
(c) retrieving parental and/or marital Social Security record(s) from the Federal Social Security database through the computer network in order to identify information for determining eligibility for SSDI benefits;
(d) determining whether the person indicated in the electronic data record is eligible for receiving SSDI benefits based on the identified information for determining eligibility of SSDI benefits and current SSDI benefit legal requirements; and
(e) indicating in the electronic data record whether the person is eligible for SSDI benefits or is not eligible for SSDI benefits.

5. The computerized method for determining eligibility for social security disability insurance benefits through a computer network as recited in claim 4, further comprising notifying caseworker of at least one electronic data record of a person who is eligible for SSDI benefits and wherein caseworker applies for SSDI benefits on behalf of the at least one person indicated in the electronic data record as eligible for SSDI benefits.

6. The computerized method for determining eligibility for social security disability insurance benefits through a computer network as recited in claim 4, wherein the information for determining eligibility for SSDI benefits is date of disability, current social security benefit status of parents if retired, whether parents are deceased or disabled, current social security benefit status of spouse if retired, and/or whether spouse is deceased or disabled.

7. The computerized method for determining eligibility for social security disability insurance benefits through a computer network as recited in claim 4, further comprising a periodic review of at least one electronic data record of persons indicated as not eligible for SSDI benefits, wherein the review comprises the steps of:
(a) if not currently known, identifying available parental and/or marital names and Social Security numbers of the person indicated in the electronic data record as not receiving SSDI benefits;
(b) inputting into the electronic data record identified available parental and/or marital names and Social Security numbers;
(c) retrieving parental and/or marital Social Security record(s) from the Social Security database through the computer network in order to identify information for determining eligibility for SSDI benefits;
(d) determining whether the person identified in the at least one electronic record is eligible for SSDI benefits based on identified information for determining eligibility for SSDI benefits and current SSDI benefit legal requirements; and
(e) indicating in the at least one electronic data record whether the person is eligible for SSDI benefits or is not eligible for SSDI benefits.

8. A computerized system for determining eligibility for social security disability insurance (SSDI) benefits through a computer network, comprising the steps of:
(a) a processor;
(b) a computer readable memory coupled to processor;
(c) a network interface coupled to the processor;
(d) software stored in the computer readable memory and executable by the processor, the software having:
i. means for accessing a Federal Social Security database through the computer network, wherein the Federal Social Security database provides records containing information relating to a person's status of SSDI and/or parental and/or marital information relating to eligibility for SSDI;
ii. means for selecting at least one person who is identified as receiving treatment for developmental disabilities and/or mental illness;
iii. means for creating an electronic data record comprising information relating to at least the identity of the person and social security number, wherein the electronic data record is recorded on the computer readable media;
iv. means for retrieving the person's Federal Social Security record containing information relating to person's status of SSDI benefits;
v. means for determining whether the person is receiving SSDI benefits based on the SSDI status information contained within the Federal Social Security database record through the computer network; and
vi. means for indicating in the electronic data record whether the person is receiving SSDI benefits or not receiving SSDI benefits.

9. The computerized system for determining eligibility for social security disability insurance benefits through a computer network as recited in claim 8, further comprising a means for accessing a State database through the network, wherein the State database provides records containing information relating to persons receiving treatment for developmental disabilities and/or mental illness from a State licensed care facility, and wherein the at least one person is selected from the State database.

10. The computerized system for determining eligibility for social security disability insurance benefits through a computer network as recited in claim 8, further comprising a means for determining whether the person indicated as not receiving SSDI benefits is eligible for receiving SSDI benefits based on current legal requirements for SSDI benefits.

11. The computerized system for determining eligibility for social security disability insurance benefits through a computer network as recited in claim 8, further comprising the means for steps performed, for at least one electronic data record of persons indicated as not receiving SSDI benefits, of:
(a) means for identifying available parental and/or marital names and Social Security numbers of the person indicated in the electronic data record as not receiving SSDI benefits;
(b) means for inputting identified available parental and/or marital names and Social Security numbers into the electronic data record;
(c) means for retrieving parental and/or marital Social Security record(s) from the Social Security database through the computer network in order to identify information for determining eligibility for SSDI benefits;
(d) means for determining whether the selected person is eligible for receiving SSDI benefits based on identified information for determining eligibility for SSDI benefits and current SSDI legal requirements; and
(e) means for indicating in the electronic data record whether the person is eligible for SSDI benefits or is not eligible for SSDI benefits.

12. The computerized system for determining eligibility for social security disability insurance benefits through a computer network as recited in claim 11, further comprising a means for notifying caseworker of at least one electronic data record of a persons eligible for SSDI benefits and wherein caseworker applies for SSDI benefits on behalf of the at least one person indicated in the electronic data record as eligible for SSDI benefits.

13. The computerized system for determining eligibility for social security disability insurance benefits through a computer network as recited in claim 11, wherein the information for determining eligibility for SSDI benefits is date of disability, current social security benefit status of parents if retired, whether parents are deceased or disabled, current social security benefit status of spouse if retired, and/or whether spouse is deceased or disabled.

14. The computerized system for determining eligibility for social security disability insurance benefits through a computer network as recited in claim 11, further comprising a means for a periodic review of at least one electronic data record of persons indicated as not eligible for SSDI benefits, wherein the periodic review comprises:
(a) a means for identifying available parental and/or marital names and Social Security numbers of the person indicated in the electronic data record as not receiving SSDI benefits if not currently known;
(b) means for receiving identified available parental and/or marital names and Social Security numbers into the electronic data record;
(c) a means for retrieving parental and/or marital Social Security record(s) from the Federal Social Security database through the computer network in order to identify information for determining eligibility for SSDI benefits;
(d) a means for determining whether the person is eligible for receiving SSDI benefits based on identified information for determining eligibility for SSDI benefits and current SSDI benefit legal requirements; and
(e) a means for indicating in the electronic data record whether the person is eligible for SSDI benefits or is not eligible for SSDI benefits.

15. A computer software product that includes a medium readable by a processor, the medium having stored thereon a set of instructions for determining eligibility for Social Security Disability Insurance (SSDI) benefits through a computer network, the instructions comprising:
(a) a first sequence of instructions which, when executed by the processor, causes the processor to establish access to a Federal Social Security database through the computer network, wherein the Federal Social Security database provides records containing information relating to a person's status of SSDI and/or parental and/or marital information relating to eligibility for SSDI;
(b) a second sequence of instructions which, when executed by the processor, causes the processor to select at least one person who is identified as receiving treatment for developmental disabilities and/or mental illness;
(c) a third sequence of instructions which, when executed by the processor, causes the processor to create an electronic data record comprising information relating to at least the identity of the person and social security number, wherein the electronic data record is recorded on the computer readable media;
(d) a fourth sequence of instructions which, when executed by the processor, causes the processor to retrieve the person's Federal Social Security Record containing information relating to the person's status of SSDI benefits;
(e) a fifth sequence of instructions which, when executed by the processor, causes the processor to determine whether the person is receiving SSDI benefits based on the SSDI status information contained within the Federal Social Security database record through the computer network; and
(f) a sixth sequence of instructions which, when executed by the processor, causes the processor to indicate in the electronic data record whether the person is receiving SSDI benefits or not receiving SSDI benefits.

16. The computer software product as recited in claim 15, wherein the instructions further comprise a seventh sequence of instructions which, when executed by the processor, establishes access to a State database through the network, wherein the State database provides records containing information relating to persons receiving treatment for developmental disabilities and/or mental illness, and wherein the second sequence of instructions, when executed by the processor, causes the process to select the at least one person from the State database through the network.

17. The computer software product as recited in claim 15, wherein the instructions further comprise a seventh sequence of instructions which, when executed by the processor, causes the processor to determine whether the person indicated as not receiving SSDI is eligible for receiving SSDI insurance benefits based on current legal requirements for SSDI benefits.

18. The computer software product as recited in claim 15, wherein the instructions further comprise which, when executed by the processor, determines eligibility for SSDI benefits for at least one electronic data record of persons indicated as not receiving SSDI benefits, comprising the instructions of:
(a) a first sequence of instructions which, when executed by the processor, causes the processor to retrieve, based on identified available information contained within the electronic data record, parental and/or marital Social Security record(s) from the Federal Social Security database through the computer network in order to identify information for determining eligibility for SSDI benefits;
(b) a second sequence of instructions which, when executed by the processor, causes the processor to determine whether the person identified in the electronic record is eligible for receiving SSDI benefits based on information for determining eligibility for SSDI benefits and current SSDI benefit legal requirements; and
(c) a third sequence of instructions which, when executed by the processor, causes the processor to indicate in the electronic data record whether the person is eligible for SSDI benefits or is not eligible for SSDI benefits.

19. The computer software product as recited in claim 18, wherein the instructions further comprise a fourth sequence of instructions which, when executed by the processor, causes the processor to notifying caseworker via an output display of at least one person who is eligible for SSDI benefits.

20. The computer software product as recited in claim 18, wherein the instructions further comprise a sequence of instructions which, when executed by the processor, causes the processor to perform a periodic review of at least one electronic data record indicated as not eligible for SSDI benefits, wherein the periodic review comprises the instructions of:
(a) a first sequence of instructions which, when executed by the processor, causes the processor to retrieve, based on identified available information contained within the electronic data record, parental and/or marital Social Security record(s) from the Federal Social Security database through the computer network in order to identify information for determining eligibility for SSDI benefits;
(b) a second sequence of instructions which, when executed by the processor, causes the processor to determine whether the person identified in the electronic data record is eligible for receiving SSDI benefits based on identified information for determining eligibility for SSDI benefits and current SSDI benefit legal requirements; and
(c) a third sequence of instructions which, when executed by the processor, causes the processor to indicate in the electronic data record whether the person is eligible for SSDI benefits or is not eligible for SSDI benefits.

21. A computerized method for identifying persons receipt of lump sum benefit payments paid out to at least one person who is/are receiving treatment for developmental disabilities and/or mental illness from a State licensed are facility through a computer network, comprising the steps of:
(a) providing a computer processing means and a computer readable media;
(b) providing access to a Federal Social Security database through the computer network, wherein the Federal Social Security database provides records containing information relating to person's receipt of payments made by the Federal Social Security Administration;
(c) selecting at least one person who is identified as receiving treatment for developmental disabilities and/or mental illness from a State licensed care facility;
(d) retrieving person's Federal Social Security record containing information relating to receipt of lump sum payments made by the Federal Social Security Administration;
(e) determining whether the selected person has received a lump sum payment from the Federal Social Security Administration as indicated from the information contained within the Federal Social Security database record through the computer network;
(f) if a lump sum payment was received, determining whether the amount of the lump sum payment exceeds the Medicaid asset limitation; and
(g) if the lump sum payment exceeds the Medicaid asset limitation, indicating in an electronic data record whether the lump sum payment is subject to appropriate disposition under the Medicaid guidelines, and notifying a caseworker to seek appropriate follow-up action.
